(19) United States
(12) Patent Application Publication
(10) Pub. No.: US 2025/0137554 A1
(43) Pub. Date: May 1, 2025

(54) VACUUM VALVE SYSTEM FOR A VACUUM TRANSPORT SYSTEM

(71) Applicant: VAT HOLDING AG, Haag (CH)

(72) Inventor: Hanspeter FREHNER, Sevelen (CH)

(21) Appl. No.: 18/835,509

(22) PCT Filed: Feb. 1, 2023
(86) PCT No.: PCT/EP2023/052385

§ 371 Date: Aug. 2, 2024

(30) Foreign Application Priority Data
Feb. 4, 2022 (DE) 10 2022 000 446.1

(51) Int. Cl. F16K 51/02; B65G 51/12; F16K 3/02; F16K 3/314

(52) U.S. Cl. CPC F16K 51/02; B65G 51/12; F16K 3/02; F16K 3/314

(57) ABSTRACT

The disclosure relates to a vacuum valve system including a valve seat arrangement having a valve opening, a first valve seat surrounding the valve opening and a second valve seat surrounding the valve opening, a closure component for closure of the valve opening with a first and a second sealing surface, and a drive unit to move the closure component relative to the valve seat arrangement from an open position to a closed position and back. The closure component has a first closure side with the first sealing surface and a second closure side with the second sealing surface. The closure component has a closure body which is arranged between and connects the first and the second closure sides. The closure component has at least one first recess open towards the edge of the closure component and an opening of the at least first recess faces in the closing direction.

The invention relates to a vacuum valve system for substantially gas-tight closure of an opening or a volume for a vacuum transport system according to the preamble of claim 1.

In general, vacuum valves for essentially gas-tight closing of a flow passage, flow path or beam path, which leads through an opening formed in a valve housing, are known from the prior art in various embodiments. Vacuum valves are used in particular in the field of IC and semiconductor production, but also, for example, in the field of electron microscopy, which must also take place in a protected atmosphere, preferably without the presence of contaminating particles.

Another application of such or similar valves can be found, for example, in the area of transport systems. These include pneumatic tube systems and vacuum transport systems. Pneumatic tube systems are a form of fast and low-personnel transportation of objects in small, cylindrical containers by means of e.g. compressed air and/or vacuum in tubes of constant caliber (typically up to approx. 20 cm).

A vacuum transport system as understood herein differs from a pneumatic tube System in particular in the size of the transported objects (significantly larger than 20 cm) and the lower internal pressure in the tube system.

In general, these vacuum transportation systems each propose a similar basic principle. In each case, it is a high-speed transportation system in which capsules or other vehicles move at very high speed, in particular the speed of sound, in a largely evacuated tube with a guide system, e.g. on a rail system, an air cushion or magnetically repulsive gliding.

For example, vacuum pumps are provided to generate a (maximum possible) vacuum in the tube. This can greatly reduce the (air) resistance in the tube, which in turn allows the vehicles moving in the tube to reach very high speeds. In the vicinity of stations, linear motors can enable high accelerations, as in a maglev train. Alternatively, a corresponding drive can be provided by the object moving in the tube.

Such a vacuum transport system has, for example, reinforced concrete supports with two adjacent transport tubes made of steel or another suitable material, e.g. metal-like, metal-containing or concrete-like material, in which at least a rough or fine vacuum prevails. The vacuum is intended to enable travel speeds of up to above the speed of sound by reducing the air resistance within the transport tube. Capsules or vehicles with space for several passengers can be moved in the tubes or loads can be transported (e.g. cars).

The capsules or vehicles should be moved with as little friction as possible. The use of an electromagnetic levitation system, for example, is proposed for this purpose.

The capsules or vehicles can, for example, be made primarily of aluminum or alternative lightweight materials and have a diameter of at least two meters. Furthermore, an unladen weight of 3 to 3.5 metric tons is proposed, wherein a payload of between 12 and 25 metric tons can be provided.

The transport tubes can have an internal diameter of slightly more than the capsule diameter and a wall thickness of at least 20 mm. The internal pressure can be kept at approx. 100 Pascal (1 millibar), for example. The pillars supporting the transport tubes can be positioned at an average distance of about 30 meters and secured against earthquakes by damping elements. It is understood that the transport tubes can also be constructed at least partially underground, for example in analogy to a subway etc., or as a tunnel.

One problem for the operation of such a vacuum transport system is generally the creation and maintenance of a desired vacuum within the system. Large losses of the internal vacuum can occur, particularly when unloading or loading or removing or inserting a transport vehicle into the transport tube.

Another problem is the fulfillment of safety requirements, particularly those imposed by the a so that potential hazards can be avoided as far as possible when operating the system. Particularly when transporting people, but also when transporting goods (e.g. hazardous goods), it is essential that the safety equipment provided allows people or goods to be evacuated from the transport tube without being damaged in an emergency.

One approach to solving the above problems is to integrate a number of separation devices along the tube. With the help of such separation devices, certain station areas along the route can be atmospherically separated from the tube and ventilated and made accessible for loading and unloading. After loading, the area is then closed off again, evacuated and the separation devices opened.

On the other hand, the separation devices can be provided at certain regular intervals along the route. This allows a certain section of the transport tube to be closed in an emergency and then ventilated so that an evacuation of people and/or goods can be initiated.

For the above-mentioned tasks, the separating devices must provide a reliable and robust seal for the transport tube when closed. In addition, the sealing effect must be reliably reproducible with multiple opening and closing processes. It must be possible to carry out the separation quickly.

It is therefore the object of the present invention to provide a separating device, in particular a vacuum valve system, for a vacuum transport system which reduces or avoids the above-mentioned disadvantages.

It is an object of the invention in particular to provide a vacuum valve system which provides improved closing and opening of the transport system, in particular with regard to speed and reliability.

These objects are solved by the realization of the characterizing features of the independent claims. Features which further develop the invention in an alternative or advantageous manner can be found in the dependent claims.

The invention relates to a vacuum valve system for substantially gas-tight closure of a valve opening, in particular a vacuum slide valve or a gate valve, for a vacuum transport system, wherein the vacuum transport system has a transport tube for transporting an object (e.g. capsule) inside along the transport tube.

The vacuum valve system has a valve seat arrangement which has the first. valve opening defining an opening axis, a first valve seat surrounding the valve opening and a second valve seat surrounding the valve opening. In addition, a closure component for essentially gas-tight closure of the valve opening is provided with a first sealing surface and a second sealing surface, wherein the first sealing surface corresponds to with the first valve seat and the second sealing surface corresponds to the second valve seat, in particular with regard to shape and/or spatial extension.

A drive unit provides a movement of the closure component relative to the valve seat arrangement such that the closure component can be moved from an open position, in which the closure component at least partially exposes the valve opening, in the closing direction into a closed position, in which the first sealing surface is in an opposing position relative to the first valve seat and the second sealing surface is in an opposing position relative to the second valve seat, and back. In particular, in the closed position, a first sealing material (seal) present between the first sealing surface and the first valve seat or a second sealing material (seal) present between the second sealing surface and the second valve seat contacts the respective sealing surface and the respective valve seat (simultaneously) and the valve opening is thereby closed essentially gas-tight. In particular, the sealing material is arranged either on the sealing surfaces or on the valve seats, e.g. vulcanized, glued or clamped on.

In the context of the present invention, the closed position is therefore to be understood as a position of the closure component in which at least one sealing surface of the closure component is opposite the associated (corresponding) valve seat, irrespective of whether a gas-tight closure of the valve opening is produced in this position or the sealing surface (including sealing material) and the valve seat are present without contact.

In particular, the valve seat arrangement can be combined with the transport tube in such a way that a gas-tight transition is provided between the valve seat arrangement and the transport tube and the valve opening corresponds to a tube cross-section or a tube opening, in particular with regard to shape, dimensions and/or position. In particular, the valve opening can be provided concentrically or contour-like to the tube opening.

The closure component has a first closure side with the first sealing surface and a second closure side with the second sealing surface. In particular, the closure sides are arranged opposite each other. In particular, the sealing surfaces face in opposite directions, in particular orthogonally to the closing direction. The closure component also has a closure body which is arranged between the first closure side and the second closure side and connects them. In particular, the sealing surfaces face away from the closure body. The closure body and the first and second closure Sides are designed (and in particular arranged) in such a way that the closure component has at least one first recess that is open towards the edge of the closure component and an opening of the at least first recess faces in the closing direction.

In particular, the recess can extend over the entire width of the closure component. In particular, the recess can also extend further to lateral areas of the closure component.

The arrangement of such a pair of sealing surfaces can provide an optional sealing of a valve opening with respect to two valve sides, i.e. with respect to a side facing the first closure side or with respect to a side facing the second closure side. This is particularly important if the valve system is used as an emergency system to close off a tunnel section. In this case, the side of the valve on which such an emergency occurs remains undefined. The system must therefore preferably provide the option of sealing both sides.

With the specific design of the closure sides together with the closure body to form the recess, two comparatively thin and spaced walls of the valve closure can be formed in the area of the recess, which have respective sealing surfaces and with which walls a seal of the opening can be provided in this area. Therefore, correspondingly thin recesses on the part of the valve seat arrangement into which the walls (closure sides) can engage are sufficient.

This is advantageous for use in a vacuum transport system, since the thin recesses (slots or gaps) on the part of the valve seat arrangement mean that only a comparatively small interruption of a guide system of the vacuum transport system has to be provided and such a small interruption means no or only a negligibly small impairment with regard to the guidance of an object in the transport system. The vacuum valve system according to the invention can thus be provided simply and directly in a vacuum transport system without requiring a disproportionately large structural intervention.

In addition, the proposed system allows the valve opening (and thus certain sections of a transport tube) to be closed quickly. This is achieved by the fact that, in contrast to the prior art, no further step, such as the removal of a part of the guide system for engaging the valve closure, is required for closing, but the valve closure can be closed directly.

In one embodiment, the at least first recess can be open on one side in the direction of the closing direction, i.e. preferably downwards when installed in a vacuum transport system.

In one embodiment, the first closure side, the second closure side and the closure body can be formed in one piece. Alternatively, these components can be firmly connected to each other, e.g. welded.

In a further embodiment, the closure body and the closure sides can be designed such that the closure component has at least one second recess, in particular open towards the edge of the closure component, and a separating web of the closure body separates the first and the second recess. It is understood that the invention also extends to the arrangement of more than two such recesses.

According to one embodiment, the valve seat arrangement can have at least one first engagement element and the at least first engagement element can be arranged between the first and the second valve seat.

In particular, the at least first engagement element can be arranged and shaped in such a way that the at least first engagement element engages in the at least first recess in the closed position.

In one embodiment, the at least first engagement element can have a guide element on its upper side facing against the closing direction for guiding the object of the transport system, in particular a rail element.

According to one embodiment, a first gap for engagement of the first closure side can be formed between the at least first engagement element and the first valve seat and a second gap for engagement of the second closure side can be formed between the at least first engagement and the second valve seat.

The engagement element can thus provide a bridging of the guide system of the vacuum transport system through a valve-side guide element and the narrow gaps (clearance) formed between the engagement element and the valve seats.

In one embodiment, the vacuum valve system can have an actuator (e.g. motor, pneumatic system, etc.), wherein the actuator is arranged such that, in the closed position, contact of the first valve seat and the first sealing surface with a first sealing material located therebetween can be provided by means of the actuator, and/or contact of the second valve seat and the second sealing surface with a second sealing material located therebetween can be provided. In particular, the actuator can be arranged for lateral (orthogonal to the closing direction) displacement of the closure component and/or for lateral displacement of at least one of the valve seats.

In one embodiment, the closure component can be mounted or suspended in such a way that the closure component is movable or displaceable orthogonally to the closing direction, in particular when the closed position is reached.

In particular, the closure component can be mounted or suspended in such a way that the displacement of the closure component orthogonal to the closing direction can be effected by a pressure difference between a first pressure applied to the first closure side and a second pressure applied to the second closure side.

The vacuum valve system can have a locking mechanism which, when released (release of the locking mechanism), only allows the closure component to be moved orthogonally to the closing direction.

The invention also relates to a closure component for a vacuum valve system according to one of the preceding claims, for (substantially) gas-tight closure of a valve opening of the vacuum valve system. The closure component has a first sealing surface and a second sealing surface, a first closure side with the first sealing surface and a second closure side with the second sealing surface, as well as a closure body arranged between the first closure side and the second closure side and connecting the closure sides. The closure body and the closure sides are designed such that the closure component has at least one first recess open towards the edge of the closure component and the at least first recess is arranged on an underside of the closure component.

The invention also relates to a vacuum valve system for substantially gas-tight closure of a valve opening for a vacuum transport system, wherein the vacuum transport system has a transport tube for transporting an object inside along the transport tube (1). The vacuum valve system has a valve seat arrangement which has the valve opening and a first valve seat (31) surrounding the valve opening. In addition, a closure component is provided for gas-tight closure of the valve opening with a first sealing surface, wherein the first sealing surface corresponds to the first valve seat, and a drive unit is provided for providing a movement of the closure component relative to the valve seat arrangement in such a way that the closure component can be moved from an open position, in which the closure component at least partially opens the valve opening, in the closing direction into a closed position, in which the first sealing surface is in an opposing position relative to the first valve seat (31), and back.

The closure component has a first closure side with the first sealing surface. The closure component also has a closure body that is connected to the first closure side. The closure body and the first closure side are designed such that the first closure side extends beyond the closure body in the closing direction and the part of the first closure side extending beyond the closure body forms an engagement section. The engagement section has at least part of the first sealing surface.

In particular, a spatial extension of the first closure side in the closing direction is greater than a spatial extension of the closure body in the closing direction.

With the specific design of the first closure side together with the closure body to form the engagement section, sealing of the opening can be provided in this region. Therefore, a correspondingly thin recess on the part of the valve seat arrangement into which the engagement section can engage is sufficient.

According to one embodiment, the valve seat arrangement can form a first gap for engagement of the engagement section. The first valve seat then extends into this gap in particular.

In contrast to the embodiment with two sealing surfaces, this design is able to provide a seal (only) on one side (in a direction orthogonal to the closing direction), but the interruption of the guide system can be correspondingly smaller and mean less interference for a transport vehicle in a vacuum transport system.

The invention also relates to a vacuum transport system having a transport tube for transporting an object inside and along the transport tube, wherein a negative pressure, in particular vacuum, can be provided inside the transport tube relative to the surrounding atmosphere. The vacuum transport system also has a vacuum valve system as described above, wherein the vacuum valve system is integrated into the vacuum transport system and connected to the transport tube.

The valve seat arrangement is connected to the transport tube in such a way that a gas-tight transition is provided between the valve seat arrangement and the transport tube and the vacuum valve system and the transport tube form a completely enclosed arrangement providing separation between the surrounding atmosphere and an interior of the vacuum trans

The valve seat arrangement provides the first valve opening as well as the first and second sealing surfaces inside the vacuum transport system. The first valve opening corresponds to a transport tube cross-section, in particular with regard to spatial expansion, position and/or shape. A control d movement of the closure component into the open position and into the closed position can be provided by means of the drive unit. An internal volume of the vacuum transport system can be closed and can be opened as a whole or in segments by means of the vacuum valve system, in particular it can be separated.

In one embodiment, the object can be a means of transportation, in particular a capsule or a vehicle, wherein the means of transportation is designed to transport one or more persons and/or goods.

Accordingly, the vacuum transport system can have a tube diameter of several meters, at least two meters. In particular, the vacuum valve system has a dimension of at least four meters in at least one spatial direction. The vacuum transport system can be designed by integrating the vacuum valve system with an emergency system for closing off a section of the tunnel or have a lock device for inserting and removing objects in and out of the transport system.

In particular, an opening axis defined by the valve opening extends coaxially or parallel to a tube axis defined by the transport tube opening.

The devices according to the invention are described in more detail below purely by way of example with reference to specific exemplary embodiments shown schematically in the drawings, and further advantages of the invention are also discussed, wherein the figures show in detail:

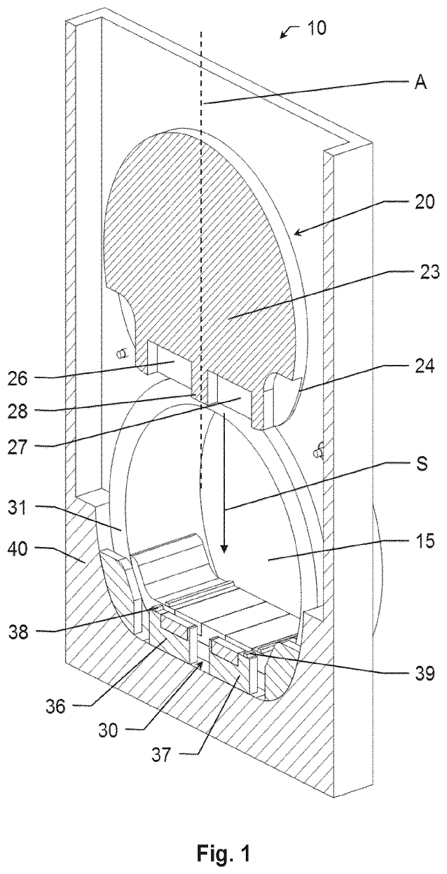

FIG. 1 shows embodiment of a vacuum valve system according to the Invention in an open position;

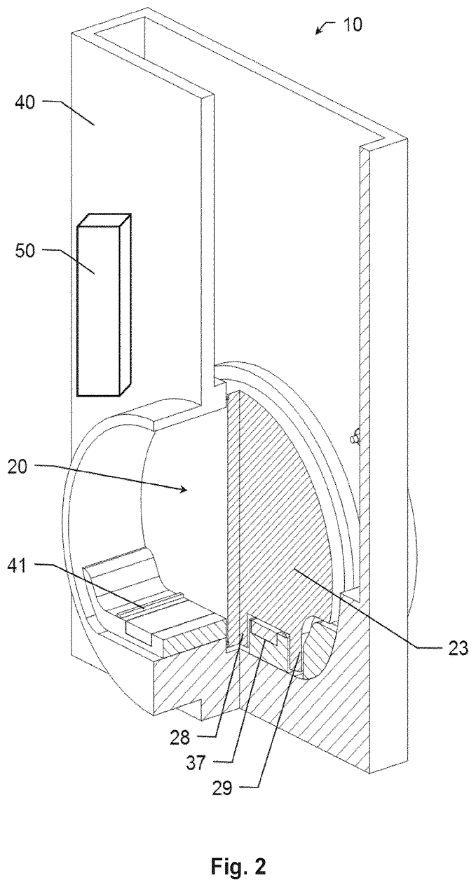

FIG. 2 shows an embodiment of a vacuum valve system according to the invention in a closed position;

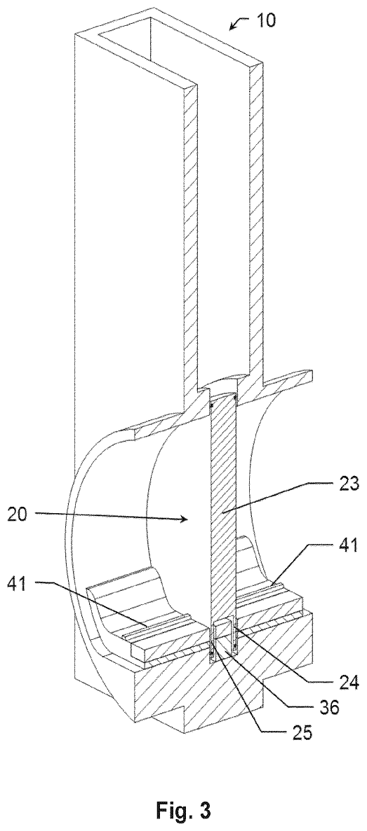

FIG. 3 shows an embodiment of a vacuum valve system according to the invention in a closed position;

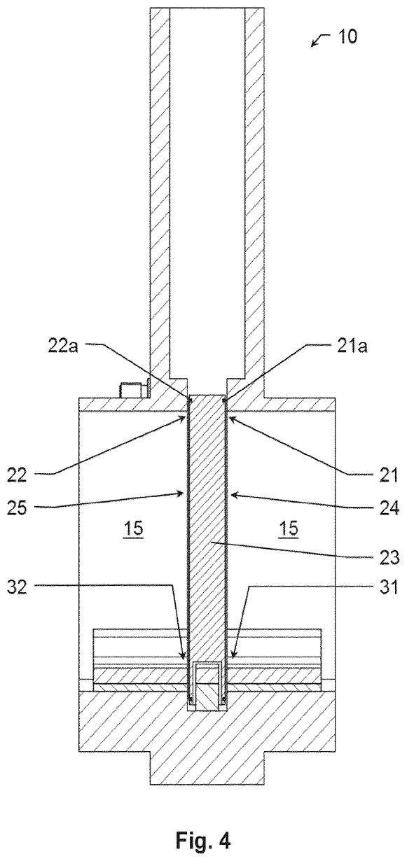

FIG. 4 an embodiment of a vacuum valve system according to the Invention in a closed position;

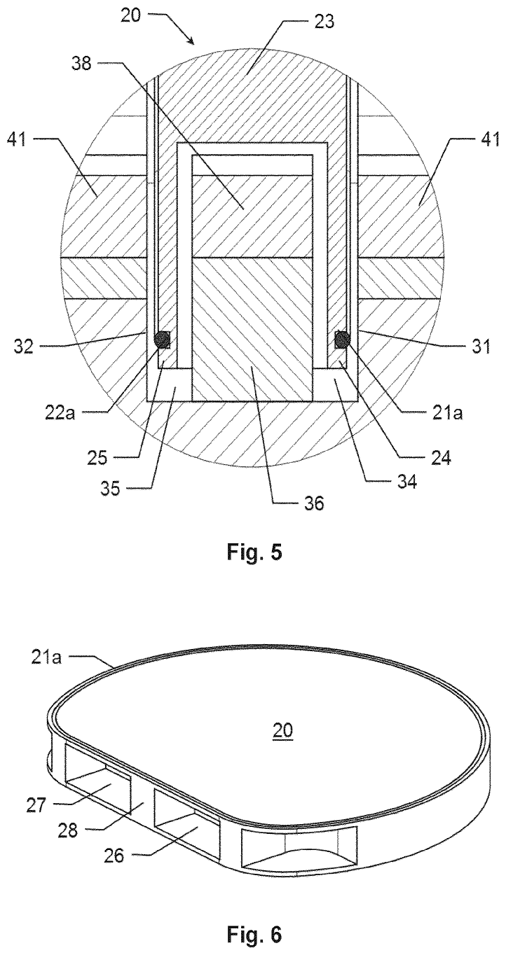

FIG. 5 shows a section of an embodiment of a vacuum valve system according to the invention in a closed position;

FIG. 6 shows an embodiment of a closure component according to the invention; and

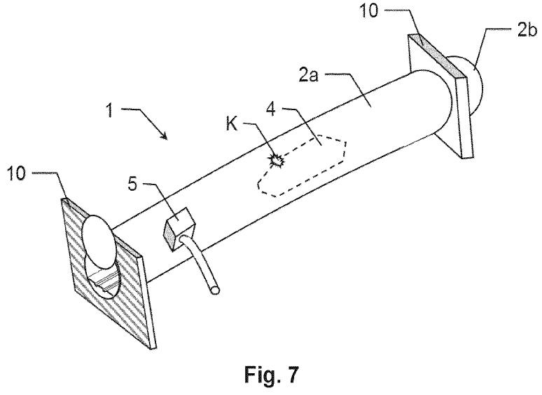

FIG. 7 Shows an embodiment of a transport tube of a vacuum transport System.

FIG. 1 shows a first embodiment of a vacuum valve system 10 according to the invention for use in a vacuum transport system in an open position, i.e. the valve opening 15 is at least partially open and not. closed.

The vacuum valve system 10 has a closure component. 20, in particular a valve disk or a valve gate, as well as a valve seat arrangement 30. The closure component 20 is designed for essentially gas-tight closure of a valve opening 15 with a first sealing surface 21 (not visible, as it is arranged on the opposite side of the closure component 20; see FIG. 4). The valve seat arrangement 30 has a first valve seat 31 which corresponds to the sealing surface 21 of the closure component 20, i.e. is designed in particular with regard to shape and spatial extension in such a way that when the sealing surfaces come into mutual contact, a complete seal of the opening 15 is provided around the valve opening 15.

In particular, the valve opening 15 is shaped and dimensioned in such a way that a transport capsule or a transport vehicle (object) of a vacuum transport system can be moved through this opening in an open position. In particular, the valve opening 15 has an internal diameter of at least two meters.

The valve seat arrangement 30 also has a second valve seat 32, which corresponds to a second sealing surface 22 (see FIG. 4) of the closure component 20, i.e. is designed in particular with regard to shape and spatial extension in such a way that, when the sealing surfaces come into mutual contact, a complete seal is provided around the valve opening 15.

The closure component 20 and the valve seat arrangement 30 can be designed to be separate and modular. In one embodiment, the closure component 20 and the valve seat arrangement 30 can also be manufactured separately from a housing 40. In another embodiment, the housing 40 may also comprise the valve seat arrangement 30 and provide its functionalities. In particular, the valve seat arrangement 30 can be designed as a cast element. Such a combination then forms a housing of the valve system, a valve seat for interacting with the valve disk 20 and a part of the vacuum transport system.

The arrangement of two opposing sealing surfaces 21 and 22, each with corresponding valve seats 31 and 32, has the advantage that sealing can take place in both directions, i.e. regardless of which side of the valve disk 20 has a negative pressure relative to the other side.

This functionality is particularly advantageous for use as an emergency separation of the transport tube in a vacuum transport system. The occurrence of a corresponding emergency, i.e. for example the occurrence of a leak in the tube or the failure of the electrical supply and thus the failure of the drive system, cannot naturally be predicted. In particular, the location of such an emergency cannot be predetermined. Such an event can therefore occur on both sides of an installed sealing component 20. This in turn requires the ability to seal the tube on both sides,

The vacuum valve 10 also has a drive unit 50 (not shown here) for moving the valve closure 20 along a linear adjustment axis A. Accordingly, the valve closure 20 can be moved from the open position shown along the axis A in the closing direction S to a closed position, as shown in FIG. 2.

The closure component 20 has a closure body 23 which connects two opposite closure sides of the closure component 20. In FIG. 1, only a first closure side 24 is visible due to the sectional view. A second closure side can be seen, for example, in FIG. 4.

The closure component 20 also has two recesses 26 and 27, which are formed, in particular delimited, by the closure sides and the closure body 23. The recesses 26 and 27 are open on one side in the direction of the closing direction (S) towards the edge of the closure component. 20. A separating web 28 between the two recesses 26 and 27 separates them spatially from one another. As shown here, the Separating web 28 can be formed by the closure body 23. The separating web 28 can provide advantageous stability and robustness in the area of the recesses,

The valve seat arrangement 30 has a first engagement element 36 and a second engagement element 37. The engagement elements 36 and 37 are arranged between the first and second valve seats 31 and 32. The engagement elements 36 and 37 are also arranged and shaped in such a way that the elements 36 and 37 engage in the recesses 26 and 27 in the closed position (e.g. FIG. 2).

The engagement elements 36 and 37 each have a guide element. 38 and 39 for guiding an object of a vacuum transport system on their upper sides pointing against the closing direction S. The guide elements 38 and 39 are designed here as rails. However, it is understood that alternative versions of any guides suitable and designed for guiding the object can be arranged, for example a channel, a groove or an element generating a magnetic field, e.g. a coil.

Due to the arrangement of the recesses 26 and 27 according to the invention and the interacting engagement elements 36 and 37, gaps (clearances) to be provided in the entire guide system (for the object moving in a vacuum transport tube) can advantageously be kept comparatively narrow. The gaps are required here so that the valve seats 31 and 32 can be superimposed (opposite positioning) on the sealing surfaces 21 and 22 and the valve 10 can be sealed. The gaps are located between the valve seats 31 and 32 and the engagement elements 36 and 37. This means that a comparatively small interruption can be provided in the guide system, allowing the object to be moved over the valve seat arrangement without interference even when the valve is open. In particular, the object is not affected in its movement due to the small gaps.

This further enables that before closing the valve 10, a part of the guide system does not first have to be removed from the transport tube (prior art) in order to create a gap and thus a valve closure can engage in the gap thus created and provide a sealing closure of the opening, but the displacement of the valve closure 20 into the closed position can take place comparatively faster and directly, i.e. without a preceding step.

FIGS. 2, 3 and 4 show the embodiment of the vacuum valve system 10 according to FIG. 1 in a closed position in different views and sections. By means of the drive unit. 50 of the vacuum valve system 10, the closure component 20 can be moved into the closed position shown.

The perspective view of FIG. 2 shows the engagement element 37 in a state engaging in the recess 27. In other words, the engagement element 37 is here enclosed by the recess 27.

The recess 27 is limited by the separating web 28 and by a further limiting element 29 provided by the closure body 23.

A guide system 41 for guiding the object in the transport tube can, for example, be connected to the housing 40 or integrated into the housing 40. This guide system 41 can be referred to here as an outer guide system or transport guide system, whereas the guide elements 38 and 39 of the vacuum valve system can be referred to as inner guide elements or valve guide elements. In particular, the inner guide elements 38 and 39 provide a transition from and to the outer guide system.

FIG. 3 shows the engagement element 36 engaging in the recess 26. The two closure sides 24 and 25 of the closure component. 20 are arranged on both sides of the engagement element 36. The two closure sides 24 and 25 are present in the area of the recess 26 in the thin gaps formed by the engagement element 36 and the first and second valve seats 31 and 32. The outer guide system 41 of the vacuum transport system is interrupted by the closure sides 24 and 25 present in the gaps.

FIG. 4 shows a further sectional view of the embodiment of the vacuum valve system 10 according to FIG. 1 in the closed position. In particular, the opposite position of the valve seats 31 and 32 to the respective sealing surfaces 21 and 22 of the closure 20 is shown here.

The first closure side 24 has the first sealing surface 21 with a first sealing material 21a and the second closure side 25 has the second sealing surface 22 with a second sealing material 22a. The sealing surfaces and the sealing materials are formed here all around the closure component 20 in such a way that, in the closed position shown, they correspond to the respective facing valve seat 31 or 32.

The vacuum valve system 10 is designed in particular in such a way that only one sealing material 21a or 22a can be brought into contact with a valve seat in the closed position.

When the closure component 20 is lowered linearly from the open position to the closed position, the closure component 20 is offset in particular in such a way that none of the sealing materials 21a or 22a initially touches a valve seat 31 or 32. The closure component 20 is located in particular in the middle between the valve seats 31 and 32 (see FIG. 5). In particular, the sealing component 20 is present without contact relative to the valve seat arrangement 30.

In the embodiment shown, the seals 21a and 22a are provided on the closure component. 20, in particular on its sealing surfaces 21 and 22. It is understood that, according to an alternative embodiment, the seals can be provided alternatively or additionally on at least one or both valve seats 31 and 32.

The respective sealing material can, in particular, be provided as an O-ring in a groove or vulcanized onto the carrier material.

FIG. 5 shows a section of the interaction of a recess of a closure component 20 with an engagement element 36 of a valve seat arrangement of an embodiment of a vacuum valve system according to the invention in the closed position.

A first gap 34 (clearance) is formed between the first valve seat 31 and the engagement element 36. A second gap 35 (clearance) is formed between the second valve seat 32 and the engagement element. 36.

The first closure side 24 protrudes into the first gap 34. The second closure side 25 protrudes into the second gap 35.

The closure sides 24 and 25 project into the gaps 34 and 35 in such a way that the seals 21a and 22a (sealing materials) of the closure component 20 are opposite the respective valve seats 31 and 32.

The closure component 20 is therefore set to a closed position here, wherein the valve opening 15 is not yet closed in a gas-tight manner.

With a further lateral movement of the closure component 20 orthogonal to the closing direction, one of the seals 21a or 22b can be brought into contact with the corresponding valve seat. The closure component 20 can be moved accordingly in the direction of the first or in the direction of the second valve seat.

This movement can be carried out using an actuator (e.g. electric motor or pneumatic), for example.

Alternatively, a relative pressure difference between the left and right sides of the closure component 20 can cause the movement. For this purpose, a locking mechanism for a lateral movement of the closure component 20 can initially be present and this locking mechanism can be released after reaching the closed position as shown.

As a result, in particular the first sealing material 21a present between the first sealing surface 21 and the first valve seat 31 or the second sealing material 22a present between the second sealing surface 22 and the second valve seat 32 can then contact the respective sealing surface 21 or 22 and (simultaneously) the respective valve seat 31 or 32 and thus close the valve opening 15 essentially in a gas-tight manner.

In other words, to close the vacuum valve system 10, the valve disk 20 can first be moved in such a way that the disk covers the valve opening 15. This movement can be provided by the drive unit 50. In this covering intermediate position, there is still no contact between a valve disk sealing surface and a corresponding valve seat sealing surface. Moving the closure 20 from this position to the gas-tight closed position can be done passively, i.e. by applying a pressure difference, or actively, I.e. by actively moving the disk 20 transversely.

In the passive case, the valve closure 20 can be held without contact between the two valve openings, e.g. by means of corresponding retaining systems (e.g. magnetic or mechanical), until the position shown in FIG. 5 is reached. Once reached, the retaining system can be released and the existing pressure difference moves the disk 20 in the direction of the vacuum side, whereby contact is made between the valve disk sealing surface and the corresponding valve seat sealing Surface and sealing of the tube is provided.

In the active case, e.g. wherein the size of the differential pressure is not sufficient for passive closing, transverse movement elements (e.g. actuators) are provided that can provide an act movement of the valve disk 20 in the direction of both valve openings. This active movement is preferably also carried out after reaching the intermediate position. The transverse movement elements can, for example, be plungers or rams that are mechanically driven or can be provided in the form of magnets,

FIG. 6 shows an embodiment of a closure component 20 according to the invention. Shown is a first seal 21a on a sealing surface of the closure component 20 as well as two recesses 26 and 27, which are separated from each other by a separating web 28. Sealing surface and seal 21a are provided on a first closure side.

FIG. 7 shows a schematic section of an exemplary transport tube 1 of a vacuum transport system. The tube 1 is preferably composed of a plurality of segments (see 2a and 2b), which can be shut off from each other by vacuum valve systems 10 according to the invention.

Flooding with air or pressure equalization with the environment is relevant for safety reasons and can be provided with a flood valve, for example. For example, a complication K could occur on a vehicle 4 (object), such as a medical emergency involving a patient, a leak in the vehicle housing or a fire. In such an emergency situation, the vehicle 4 must stop as quickly as possible. If the situation permits, the vehicle 4 could stop in a defined transport tube segment, or in any segment, in which case sensors for detecting the vehicle 4 are preferably present. The segment in question can then be separated using the vacuum valve systems 10.

If the vehicle 4 comes to a standstill in such a way that a valve cannot close, the next available valve can advantageously be accessed. Otherwise, a device could also be provided that moves the vehicle 4 so that the valve area is free and the valve can close.

The vehicle 4 can be a capsule or a vehicle, for example, and can be designed to transport at least one person and/or goods.

It is understood that the figures shown only schematically represent possible exemplary embodiments. According to the invention, the various approaches can also be combined with each other and with valves for closing transport systems of the prior art.

1. A vacuum valve system for substantially gas-tight closure of a valve opening for a vacuum transport system, wherein the vacuum transport system comprises a transport tube for transporting an object inside along the transport tube,
comprising
a valve seat arrangement which has the valve opening , a first valve seat surrounding the valve opening and a second valve seat surrounding the valve opening,
a closure component for gas-tight closure of the valve opening with a first sealing surface and a second sealing surface, wherein the first sealing surface corresponds to the first valve seat and the second sealing surface corresponds to the second valve seat, and
a drive unit for providing a movement of the closure component relative to the valve seat arrangement such that the closure component moves from an open position, in which the closure component at least partially clears the valve opening, in the closing direction into a closed position, in which the first sealing surface is in an opposing position relative to the first valve seat and the second sealing surface is in an opposing position relative to the second valve seat, and back, wherein
the closure component has a first closure side with the first sealing surface and a second closure side with the second sealing surface,
the closure component has a closure body which is arranged between the first closure side and the second closure side and connects them,
the closure body and the closure sides are designed in such a way that the closure component has at least one first recess that is open towards the edge of the closure component, and
an opening of the at least first recess faces in the closing direction.

2. The vacuum valve system according to claim 1, wherein the at least first recess is open on one side in the direction of the closing direction.

3. The vacuum valve system according to claim 1, wherein the first closure side, the second closure side and the closure body are formed in one piece.

4. The vacuum valve system according claim 1, wherein the closure body and the closure sides are designed such that the closure component has at least one second recess, in particular open towards the edge of the closure component, and a separating web of the closure body separates the first and the second recess.

5. The vacuum valve system according to claim 1, wherein the valve seat arrangement has at least one first engagement element and the at least first engagement element is arranged between the first and the second valve seat.

6. The vacuum valve system according to claim 5, wherein the at least first engagement element is arranged and shaped in such a way that the at least first engagement element engages in the at least first recess in the closed position.

7. The vacuum valve system according to claim 5, wherein the at least first engagement element has a guide element, on its upper side facing against the closing direction for guiding the object of the transport system, in particular a rail element.

8. The vacuum valve system according to claim 5, wherein a first gap for engagement of the first closure side is formed between the at least first engagement element and the first valve seat and a second gap for engagement of the second closure side is formed between the at least first engagement element and the second valve seat.

9. The vacuum valve system according to claim 1, wherein the vacuum valve system has an actuator, wherein the actuator is arranged such that by means of the actuator, in the closed position,
a contact of the first valve seat and the first sealing surface with a first sealing material located therebetween can be provided, and/or
a contact of the second valve seat and the second sealing surface with a second sealing material located therebetween can be provided.

10. The vacuum valve system according to claim 1, wherein the closure component is mounted or suspended in such a way that the closure component is movable or displaceable orthogonally to the closing direction, in particular when the closed position is reached.

11. The vacuum valve system according to claim 10, wherein the closure component is mounted or suspended in such a way that the displacement of the closure component orthogonal to the closing direction can be effected by a pressure difference between a first pressure applied to the first closure side and a second pressure applied to the second closure side.

12. A closure component for a vacuum valve system according to claim 1, for gas-tight closure of a valve opening of the vacuum valve system, comprising
a first sealing surface and a second sealing surface,
a first closure side with the first sealing surface and a second closure side with the second sealing surface,
a closure body arranged between the first closure side and the second closure side and connecting the closure sides, wherein
the closure body and the closure sides are designed such that the closure component has at least one first recess open towards the edge of the closure component, and
the at least first recess is arranged on an underside of the closure component.

13. A vacuum valve system for substantially gas-tight closure of a valve opening for a vacuum transport system, wherein the vacuum transport system has a transport tube for transporting an object inside along the transport tube, comprising
a valve seat arrangement which has the valve opening and a first valve seat surrounding the valve opening,
a closure component for gas-tight closure of the valve opening with a first sealing surface, wherein the first sealing surface corresponds to the first valve seat, and
a drive unit for providing a movement of the closure component relative to the valve seat arrangement in such a way that the closure component can be moved from an open position, in which the closure component at least partially clears the valve opening, in the closing direction into a closed position, in which the first sealing surface is in an opposing position relative to the first valve seat, and back,
wherein
the closure component has a first closure side with the first sealing surface,
the closure component has a closure body that is connected to the first closure side,
the closure body and the first closure side are designed such that the first closure side extends beyond the closure body in the closing direction and the part of the first closure side extending beyond the closure body forms an engagement section, and
the engagement section has at least part of the first sealing surface.

14. A vacuum transport system, having
a transport tube for transporting an object inside and along the transport tube, wherein a negative pressure can be provided inside the transport tube relative to the surrounding atmosphere, and
a vacuum valve system integrated into the vacuum transport system and connected to the transport tube according to claim 1, wherein
the valve seat arrangement is connected to the transport tube in such a way that
a gas-tight transition is provided between the valve seat arrangement and the transport tube, and
the vacuum valve system and the transport tube form a completely enclosed arrangement providing a separation between the surrounding atmosphere and an interior of the vacuum transport system,
the valve seat arrangement provides the valve opening, the first sealing surface and the second sealing surface inside the vacuum transport system,
the valve opening corresponds to a tube cross-section,
a controlled movement of the closure component into the open position and into the closed position can be provided by means of the drive unit, and
an internal volume of the vacuum transport system can be closed and can be opened as a whole or in segments by means of the vacuum valve system.

15. The vacuum transport system according to claim 14, wherein the object is a means of transportation, wherein the means of transportation is designed to transport a person and/or goods.
